(19) United States
(12) Patent Application Publication
(10) Pub. No.: US 2026/0136032 A1
(43) Pub. Date: May 14, 2026

(54) TRAINING METHOD OF AN END-TO-END NEURAL NETWORK BASED COMPRESSION SYSTEM

(71) Applicant: InterDigital VC Holdings, Inc., Wilmington, DE (US)

(72) Inventors: Frederic Lefebvre, Rennes (FR); Franck Galpin, Thorigne-Fouillard (FR); Fabien Racape, San Francisco, CA (US); Hyomin Choi, Sunnyvale, CA (US)

(21) Appl. No.: 19/119,942

(22) PCT Filed: Oct. 10, 2023
(86) PCT No.: PCT/US2023/034801

§ 371 Date: Apr. 10, 2025

Related U.S. Application Data
(60) Provisional application No. 63/414,977, filed on Oct. 11, 2022.

(51) Int. Cl. H04N 19/42; G06N 3/0455; H04N 19/124

(52) U.S. Cl. CPC H04N 19/42; G06N 3/0455; H04N 19/124

(57) ABSTRACT

A method is disclosed that comprises training encoder and decoder neural networks to learn encoder and decoder parameters, wherein the method comprises, during training, quantizing and freezing learned decoder parameters decoding layer per decoding layer at different epochs.

### CROSS REFERENCE TO RELATED APPLICATIONS

This application claims the benefit of U.S. Provisional Application No. 63/414,977, filed on Oct. 11, 2022, which is incorporated herein by reference in its entirety.

### TECHNICAL FIELD

At least one of the present embodiments generally relates to a method for training encoder and decoder neural networks.

### BACKGROUND

In recent years, novel image and video compression methods based on neural networks have been developed. Contrary to traditional methods which apply pre-defined prediction modes and transforms, ANN-based methods rely on many parameters that are learned on a large dataset during a training stage, by iteratively minimizing a loss function. In the case of compression, the loss function is, for example, defined by the rate-distortion cost, where the rate stands for the estimation of the bitrate of the encoded bitstream and the distortion quantifies the quality of the decoded video against the original input. Traditionally the quality of the decoded input image is optimized, for example based on the measure of the mean squared error or an approximation of the human-perceived visual quality.

The Joint Video Exploration Team (JVET) between ISO/MPEG and ITU is currently studying ANN-based tools to replace some modules of the latest video coding standard H.266/VVC, as well as the replacement of the whole structure by end-to-end auto-encoder methods.

### SUMMARY

In one embodiment, a method is disclosed that comprises training encoder and decoder neural networks to learn encoder and decoder parameters, wherein the method comprises, during training, quantizing and freezing learned decoder parameters decoding layer per decoding layer at different epochs.

In another embodiment, a method is disclosed that comprises training encoder and decoder neural networks to learn encoder and decoder parameters, wherein the method comprises, during training, quantizing and freezing learned encoder parameters encoding layer per encoding layer at different epochs.

Further embodiments that can be used alone or in combination are described herein.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon a bitstream generated according to the methods described above. One or more embodiments also provide a method and apparatus for transmitting or receiving the bitstream generated according to the methods described herein.

### BRIEF DESCRIPTION OF THE DRAWINGS

FIG. 1 illustrates a block diagram of a system within which aspects of the present embodiments may be implemented;

FIG. 2 illustrates an example of an end-to-end neural network based compression system:

FIG. 3 illustrates an example of a neural network end-to-end autoencoder for image compression called Factorized Prior according to the prior art:

FIGS. 4A and 4B illustrate examples of neural network end-to-end autoencoders for image compression according to various embodiments:

FIG. 5 depicts an example of a Rectified Linear Unit (ReLU) activation function:

FIG. 6 illustrates a flowchart of a training method of a neural network end-to-end autoencoder according to another embodiment; and

FIG. 7 illustrates a flowchart of a training method of a neural network end-to-end autoencoder according to another embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions 5 may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

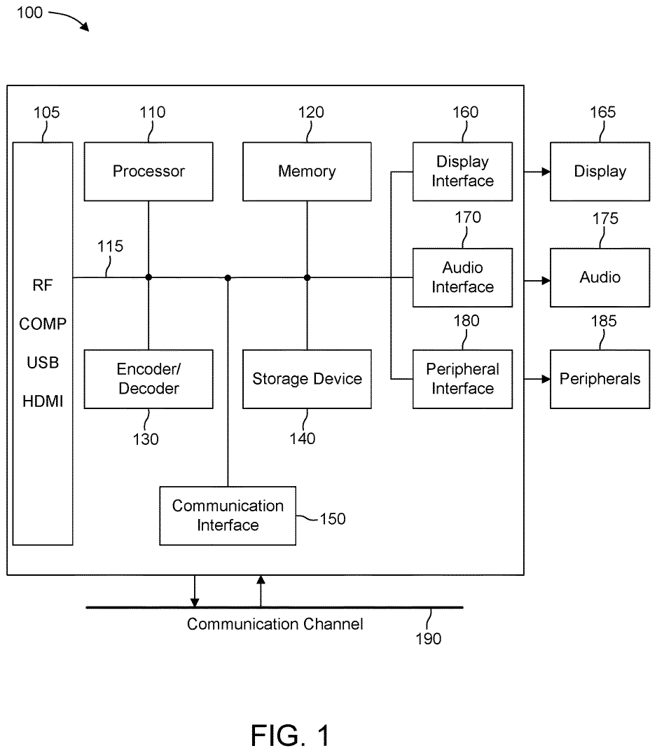

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder module 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder module 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

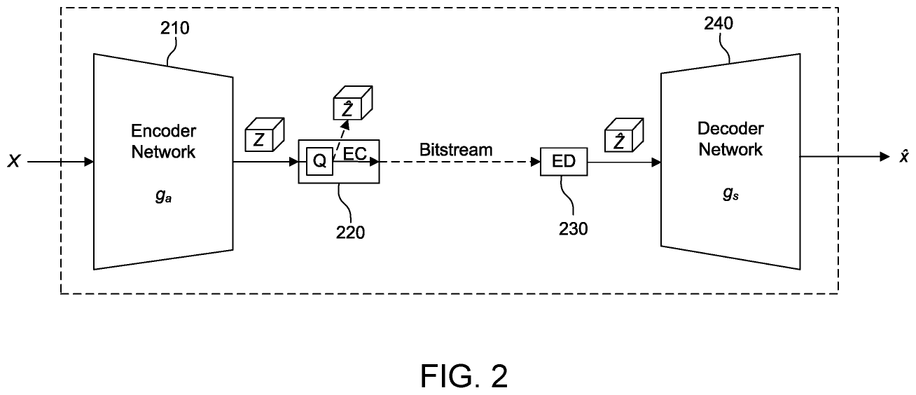

FIG. 2 shows an example of an end-to-end neural network based compression system. Input X to the encoder part of the network can include:
an image or frame of a video:
a part of an image:
a tensor representing a group of images:
a tensor representing a part (crop) of a group of images.

In each case, the input can have one or multiple components or channels, e.g.: monochrome. RGB or YCbCr components. As shown in FIG. 2, input X is fed into the encoder neural network gₐ( ) (210, also known as analysis transform). gₐ( ) is usually a sequence of downsampling convolutions followed by activation functions. Large strides in the convolution can be used to reduce spatial resolution. A stride is the step (defined for example in number of pixels) between a current position of a filter kernel and a next position. When the stride is 1, the filters move one pixel at a time, usually in both horizontal and vertical directions. When the stride is 2, the filters move 2 pixels at a time. This produces a smaller output, e.g., Cₒᵤₜ×H/2×W/2 if the input has dimensions Cᵢₙ×H/2×W/2, where H and W are the spatial dimensions, Cour and Cm are the number of channels. The higher the stride, the smaller the output tensor. Said otherwise, the encoder neural network (210) is usually composed of a sequence of convolutional layers with stride, allowing to reduce spatial resolution of the input while increasing the depth, i.e., the number of channels of the input. Pooling (e.g., Average Pooling, Max Pooling, etc.) or squeeze operations (space-to-depth via reshaping and permutations) can also be used instead of stride convolutional layers. The encoder neural network can be seen as a learned transform gₐ( ).

The output of the analysis transform is Z=gₐ(X) that is a 3-dimensional tensor (referred to as a tensor), also called latent tensor or latent representation. From a broader perspective, a set of latent variables constructs a latent space, which is also frequently used in the context of neural network-based end-to-end compression. Herein, the terms latent variables and latent coefficients may be used interchangeably. The latent representation Z is quantized (Q) and entropy coded (EC) (220) as a binary stream (bitstream) for storage or transmission. Entropy coding exploits probability distribution of symbols to be encoded. In the following, we suppose that EC embeds the quantization operation (Q). The bitstream is the set of coded syntax elements and payloads of bins representing the quantized symbols, that may be transmitted to the decoder or stored on a storage medium.

The decoder first decodes (ED, 230) quantized symbols from the bitstream to obtain 2, the quantized version of Z. The decoder network gₛ( ) (240, also known as synthesis transform) generates reconstructed input: \hat{X}=gₛ(\hat{Z}), an approximation of the original X from the quantized latent representation \hat{Z}. gₛ( ) is usually a sequence of up-sampling convolutions (e.g. “deconvolutions” or convolutions followed by up-sampling filters) or depth-to-space operations. The decoder network (240) may be seen as a learned inverse transform gₛ( ) operating on quantized coefficients, or a denoising and generative transform. The output of the decoder is the reconstructed image or a group of images \hat{X}.

The encoder and decoder encoder neural networks are composed of multiple layers, such as convolutional layers. Each layer can be described as a function that first multiplies the input by a weight, adds a vector called the biases and then applies a nonlinear function (an activation function) on the resulting values. The values of the weights and the biases are denoted by the term “neural network parameters”. In such a compression system, the encoder and decoder are fixed, based on a predetermined model supposed to be known when encoding and decoding (inference stage). To this aim, the encoder and the decoder neural networks are trained (i.e., the neural network parameters are learned) simultaneously so that they are compatible. Indeed, to learn the parameters (e.g., weights and biases) of the encoder and decoder, the end-to-end neural network is trained on massive databases D of images. The learning stage comprises a forward pass and a backward pass. The forward pass designates the flow direction from “input” to “output”. The backward pass designates the flow direction from “output” to “input” during which gradients of the loss function are propagated backwards. The aim of the backward pass is to distribute the total error back to the network so as to update the parameters in order to minimize a cost function (loss function). The updates are determined by the gradients of the cost function with respect to those parameters. The parameters are updated in such a way that when the next forward pass utilizes the updated parameters, the total error is reduced by a certain margin (until the minima is reached).

The transform gₐ( ) and gₛ( ), more precisely their parameters, e.g., weights and biases, are learned by minimizing a loss function also called cost function that compares an output of the network with a known data set. e.g., an input image. A first type of loss function may be based on an “objective” metric, typically a Mean Squared Error (MSE) or based on structural similarity (SSIM).

A second type of loss function may be based on “subjective” (or subjective by proxy), typically using Generative Adversarial Networks (GANs) during the training stage or advanced visual metric via a proxy NN.

The results obtained using the first type of loss function may not be perceptually as good as the second type of loss function, but the fidelity to the original signal (image) is higher.

The encoder and decoder networks may be trained using several types of training datasets. The same network can be first trained on a generic training set, allowing a satisfactory performance on a large range of content types, and then it is possible to fine tune the model using a specific training set for a specific usage, improving the performance on a domain specific content.

In the above, the probability distributions or more simply the distributions used by the entropy encoder EC are learnt once (one distribution for each channel of the latent representation) and do not change depending on the input image. More sophisticated architectures called a “hyper-autoencoder” exist where an additional NN (hyper-prior) is added to the network to jointly learn the parameterized probability distributions of the latent representation variables as the output of the encoder.

Once the parameters of the encoder and decoder neural networks are learned, the networks may be effectively used to encode a specific image X. Inference refers to the effective usage of the neural networks defined by the learned parameters. Said otherwise, inference applies a trained neural network model and uses it to infer a result. Inference comes after training as it requires a trained neural network model.

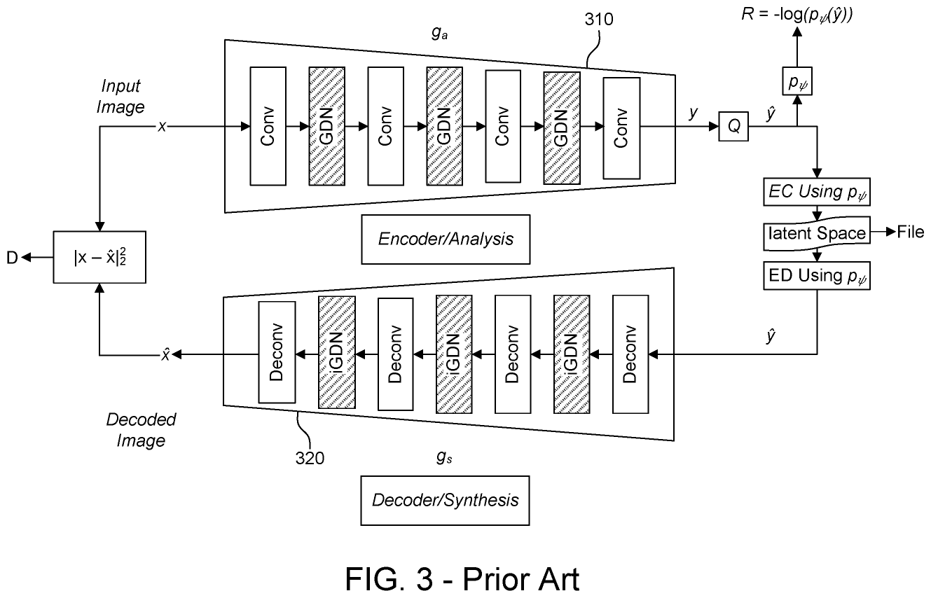

FIG. 3 shows an example of a neural network end-to-end autoencoder for image compression called Factorized Prior described in document from Ballé et al. entitled “Variational image compression with a scale hyperprior,” ArXiv1802.01436 Cs Eess Math, May 2018. This end-to-end autoencoder comprises an encoder neural network 310 (associated with a transform gₐ( )) and a decoder neural network 320 (associated with a transform gₛ( )). In this end-to-end autoencoder, gₐ (310) comprises 4 convolutional layers Conv and 3 nonlinear Generalized Divisive Normalizations (GDN) and gₛ (320) comprises 4 deconvolutional layers Decony and 3 nonlinear inverse Generalized Divisive Normalizations (iGDN). The parameters of the convolutional layers are denoted as number of filters×kernel support height×kernel support/down- or upsampling stride, e.g., as M×5×5. In an example, M=192 or 128 and stride is equal to 2. Downsampling is applied on the encoder side and upsampling on the decoder side.

The GDN comprises linear transformations followed by a generalized form of divisive normalization. This activation/normalization layer includes a division and therefore requires the use and generation of intermediate and output floating point values. The iGDN includes a square root, and thus requires the use and generation of intermediate and output floating point values. In the above autoencoder, a quantizer (Q) rounds the floating-point values of the latent variables, i.e., the output of gₐ, to integer values before feeding these integer values to the entropy encoder (EC). The entropy codec (Entropy Coder and Entropy Decoder) uses cumulative distribution functions (CDFs) as prior to compress the quantized latent tensor. These CDFs (p_{ψ}) are learnt during training. In this version, the CDFs are frozen after the model training is done. One CDF is computed for each channel in the latent representation, i.e., entire latent variables (coefficients) for a channel share the same prior for entropy coding. The parameters (e.g., weights and biases) of the encoder and decoder neural networks are learned during training by minimizing a loss function defined as R+λ·D, where R is a rate and D a distortion between an input image x and a reconstructed image \hat{x}. The rate R is for example defined as −log(p_{ψ}(ŷ) and the distortion D as |x−\hat{x}|₂², where x is the input image, \hat{x} is the reconstructed image, y is the latent representation (i.e. the output of the encoder), ŷ is the quantized latent and ψ represent the parameters of the cumulative distribution functions (CDFs).

Video compression systems, in particular decoders embedded in low-end devices such as smartphone or set-top-boxes for instance, need to be capable to process videos of increasing resolutions and framerates, involving extremely challenging computational complexity and memory management. Despite the rise and rapid improvement of graphical process units, which enable the use of highly parallelized floating-point operations in deep neural networks, lightweight decoder architectures is key for potential deployment in the foreseeable future.

The Fully Factorized Prior model, described above with respect to FIG. 3 and its variants are widely used in end-to-end image and video compression. Almost all models use GDN at the encoder in which a division is performed and iGDN at the decoder in which a square root is performed. Such floating-point operations have a high computational complexity and memory management which may be an obstacle for a large deployment in low-end devices.

To avoid using floating point operations when using (inferring stage) a Neural Network, quantization is used since the training process cannot be entirely performed using integer values. PyTorch is a machine learning framework based on the Torch library. It discloses three options to quantize a neural network in order to reduce its complexity.

In a first option known as Post Training Dynamic Quantization, the parameters of the network are quantized dynamically at the inference stage. The main disadvantage is that the quantization is performed after training. There is no feedback, thus no guaranty that the performance estimations calculated at training will be preserved at the inference stage.

In a second option known as Post Training Static Quantization, the model parameters, i.e., weights, biases and activations, are quantized at the end of the training phase. A dataset is then used to adjust the parameters and reduce the distortion between the results when performing inference with and without quantization. The main advantage is that no change is done during the training, as this is performed post quantization. However, performances suffer from some accuracy loss for complex network with many layers.

In a third option known as Quantization Aware Training for Static Quantization, the model is trained in floating point but using a fake quantization module, i.e., the operations are still performed in floating point but include clamping and rounding to simulate integer conversion. In this approach, the full network is quantized with the same bits of quantization. This is best approach in terms of performances, but it is not flexible. Besides, the fake quantization approach is not optimal to represent the actual accurate inference which will be performed.

In the document from Balle et al entitled “Integer Networks for Data Compression with Latent-Variable Models” published in ICLR in 2019, the authors explained that ANNs based on floating point can lead to strong failure when deployed on heterogeneous platform such as embedded platform. They propose to use integer arithmetic in these ANNs. To this aim, they disclose a quantized network, so called integer network. The gradient is computed and kept in floating point while the parameters are quantized. The main drawback is the usage of integer network for both encoder and decoder while in some cases the integer decoder is enough and needs to be tuned for heterogenous platform.

Embodiments described hereafter may aim at decreasing the complexity of the decoder by discarding division, square root and floating point in the decoder while keeping a similar rate distortion cost. In these embodiments, the encoder compensates the low complexity of the decoder during the training stage. In order to avoid diverging decoded output with respect to the expectations of encoding, the encoder needs to know the bit-exact behavior of the decoder. Consequently, the encoder and the decoder neural networks are trained simultaneously.

The complexity of the decoder is reduced by replacing computationally costly normalization layers inverse GDN by basic activation layers and by quantizing weights and biases of the convolutional layers in the decoder to perform integer convolutions. The complexity reduction of the decoder is compensated by the encoder during training. This makes it possible to keep similar rate distortion performances as the decoder disclosed on FIG. 3. After a predefined number of epochs over the training set, during which the whole system is trained “normally” end-to-end, the decoder parameters are quantized and further frozen/fixed, i.e., are no more updated. The training then continues with backward propagation of the gradients to update the encoder parameters while quantized decoder parameters are not updated anymore.

The method disclosed is not limited to the decoder and may be also implemented in the encoder in addition to the decoder or in the encoder only. In the description below, although the approach is not limited to the decoder, we focus on the decoding process which is implemented in embedded low-end platforms. Indeed, complexity is generally more critical in the decoders. However, the same principles may be implemented on the encoder side.

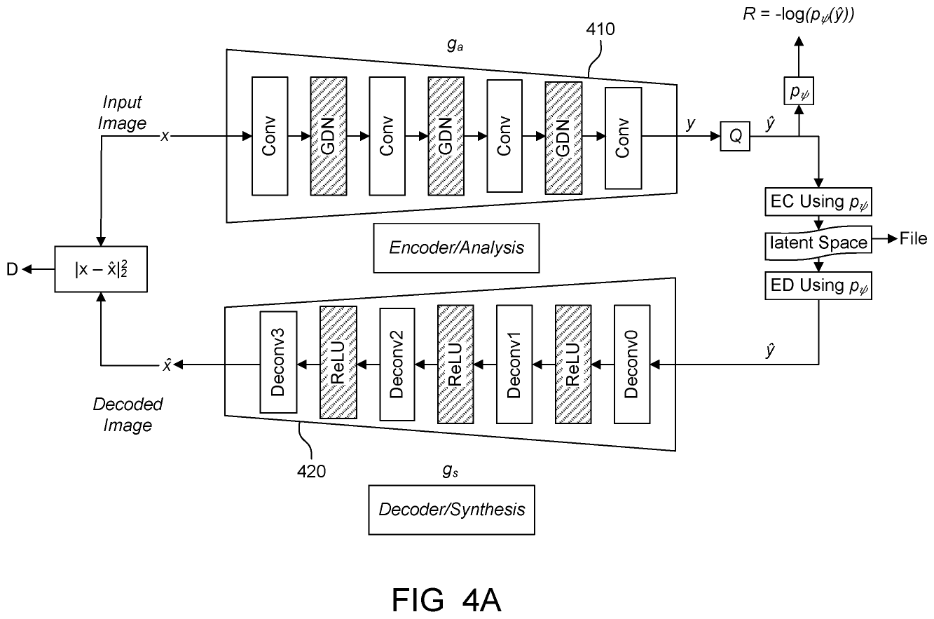

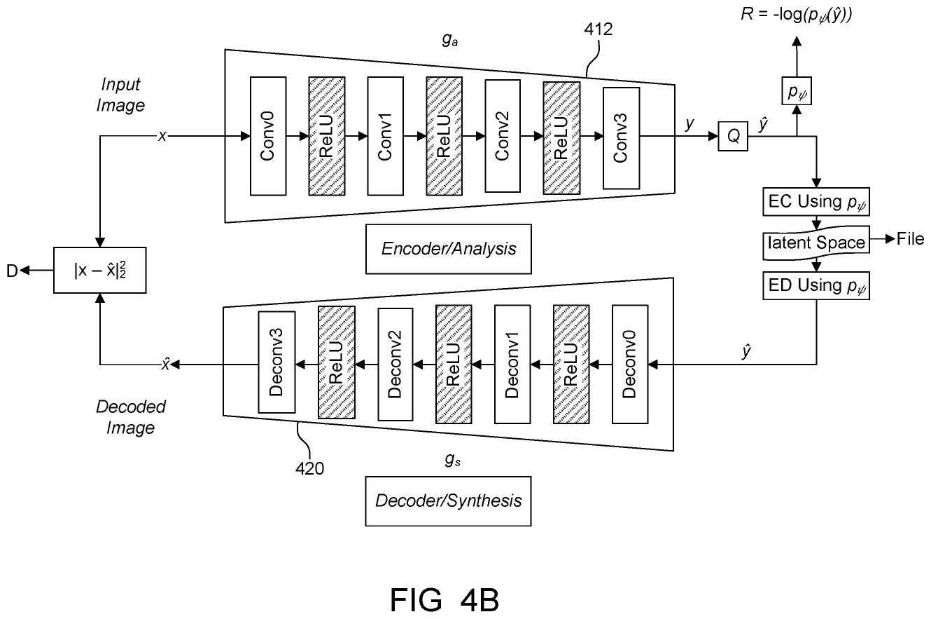

FIG. 4A shows an example of a neural network end-to-end autoencoder for image compression according to an embodiment. The methods proposed herein are not limited to the use of autoencoders. Any end-to-end differentiable codec can be considered. e.g., codec using video compression transformers.

This end-to-end autoencoder comprises an encoder neural network 410 (associated with a transform gₐ( )) and a decoder neural network 420 (associated with a transform gₛ( )). In this end-to-end autoencoder, gₐ (310) comprises n convolutional layers Conv and m nonlinear Generalized Divisive Normalizations (GDN) and gₛ (320) comprises p deconvolutional layers Deconvᵢ (i∈{0,1,2,3}) and q ReLUs (stands for Rectified Linear Unit). Other low complexity activation functions may be used instead of ReLU, e.g., Leaky ReLU, etc. In the example depicted on FIG. 4, n=p=4 and m=q=3. However, other values can be used.

The encoder neural network architecture 410 may be identical, or similar, to the encoder neural network architecture 310 of the encoder of FIG. 3. The GDN comprises linear transformations followed by a generalized form of divisive normalization. This activation/normalization layer includes a division, therefore requiring the use and generation of intermediate and output floating point values. In this end-to-end autoencoder, the quantizer (Q) rounds the floating-point values of the latent variables, i.e., the output of gu to integer values before feeding to the entropy encoder. The entropy codec (Entropy Coder and Entropy Decoder) uses cumulative distribution functions (CDFs) as prior, to compress the quantized latent tensor. These CDFs (p_{ψ}) are learnt during training. In this version, the CDFs are frozen after the model training is done. One CDF is computed for each channel in the latent representation, i.e., entire latent variables (coefficients) for a channel share the same prior for entropy coding. The parameters of the encoder and decoder networks are learned by minimizing a loss function defined as R+λ·D, where R is a rate and D a distortion between an input image x and a reconstructed image \hat{x}. The rate R is for example defined as −log (p_{ψ}(ŷ)) and the distortion D as |x−\hat{x}|₂², where x is the input image, \hat{x} is the reconstructed image, y is the latent representation (i.e. the output of the encoder), ŷ is the quantized latent and ψ represent the parameters of the distribution functions (CDFs). However, the method disclosed with respect to FIG. 4 is not limited by the type of Loss function.

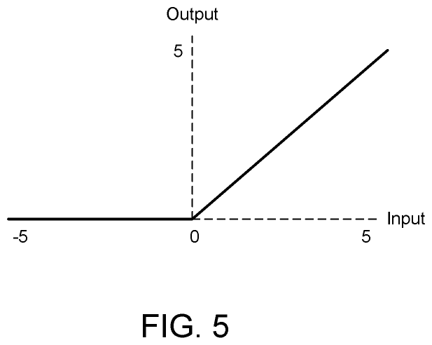

The decoder neural network architecture 420 is simplified with respect to the decoder neural network architecture 320 to avoid square root and division. To this aim, each iGDN activation function is replaced by a ReLU activation function such as the one depicted in FIG. 5 which outputs a maximum value between an input value and 0. Other low complexity activation functions may be used instead of ReLU, e.g., Leaky ReLU, etc. In addition, an integer deconvolution replaces each iGDN. This decoder neural network architecture does not involve any square root or division but only integer operations (e.g., addition and multiplication) and is thus simplified.

Integer deconvolution is obtained by quantizing and freezing (also called setting to a fixed value or fixing) the decoder parameters (e.g., weights and biases of the deconvolutional layers layers) during training after a given number of epochs while continuing to train the encoder so that it adapts to the quantized frozen/fixed decoder parameters. At the end of the learning stage, the parameters (e.g., weights and biases) of the deconvolution layers of the decoder are thus integer parameters. The parameters of the convolution layers of the encoder may be floating points parameters. However, these floating points parameters are learned knowing that the decoder uses integer parameters and ReLU activation functions.

Said otherwise, the encoder and decoder neural networks being trained together, the simplification of the decoder is taken into account by the encoder during the training (i.e learning of the encoder parameters). The encoder neural network may thus compensate for the distortion induced by the quantization of the decoder neural network's parameters (e.g. weights and biases). The decoder neural network being of lower complexity may be embedded in low-end devices such as smartphone or set-top-boxes for instance while preserving the rate distortion performance.

In a variant of FIG. 4A depicted in FIG. 4B, the encoder neural network 412 is modified so that each GDN are replaced by a ReLU.

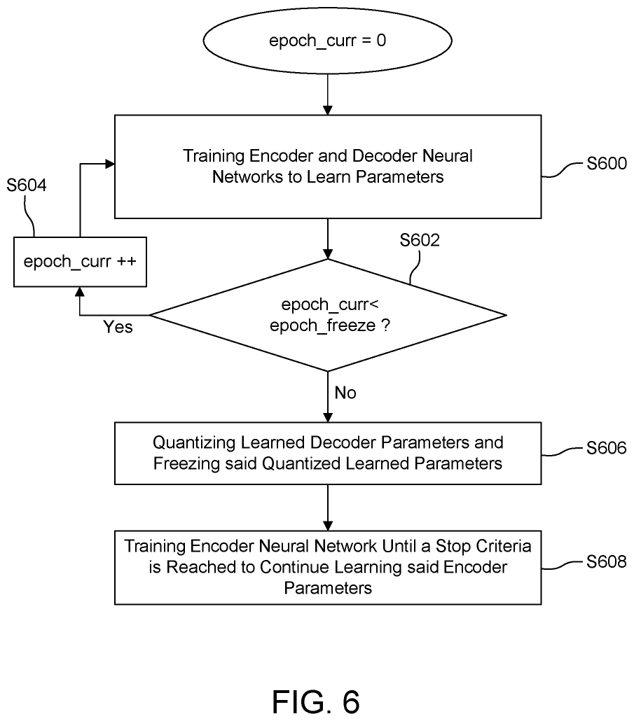

FIG. 6 illustrates an example of flowchart of a training method of a neural network end-to-end autoencoder according to an embodiment.

A number of epochs number_of_epochs is considered for training, i.e. the training stops when a current number of epochs epoch_curr is equal to number_of_epochs. Both epoch_curr and number_of_epochs are integer numbers. In terms of artificial neural networks, an epoch refers to one cycle through the full training dataset. In an epoch, all of the data of the training dataset are used exactly once. The current number of epochs epoch_curr is thus incremented by one at each training cycle through the full training dataset. An epoch is made up of one or more batches, where a part of the training dataset is used to train the neural network. The current number of epochs epoch_curr is first initialized to a value, e.g., 0.

In a step S600, the encoder and decoder neural networks are trained to learn their parameters (e.g., weights and biases) for one epoch, one cycle through the full training dataset. The parameters are floating point parameters.

In a step S602, the current number of epochs epoch_curr is compared to a value epoch freeze, e.g., epoch freeze=number_of_epochs/2. In the case where the current number of epochs epoch_curr is below epoch_freeze, the method continues at step S604. At step S604, the current number of epochs epoch_curr is incremented by one and the method continues for a next epoch at step S600.

In the case where the current number of epochs epoch_curr is larger than or equal to epoch_freeze, the method continues at step S606.

At step S606, the learned decoder parameters of all the decoder layers, i.e., all the deconvolutional layers, are quantized and frozen/fixed. Said otherwise, the parameters (e.g., weights and biases) of the deconvolutional layers deconvᵢ of the decoder neural network are not updated anymore until the end of the training.

The parameters of the decoder neural networks are quantized with n-bits of precision but still temporarily stored as float for floating point operations during the training stage. The quantization range is [−2^{nbits-1}, +2^{nbits+1}].

$$quantizer = {2}^{n}$$

Then, the matrix X={deconvᵢ}_{i=0 . . . 3} is quantized as follows:

$$newX = \frac{newround ( X * quantizer )}{quantizer}$$

where newround( )=(torch·round(x)−x)·detach ( )+x defined using Torch backend. Indeed, a uniform quantization is thus defined that it is differentiable in case of forward or backward propagation. The classical round( ) function, used in uniform quantization, is gradient NULL. Function that returns gradient NULL cannot be used in backward propagation. Said otherwise, a network will not learn anything in the case where a NULL gradient is returned. A workaround is to use the straight-through estimator (STE) so that the gradient becomes non-NULL. STE ignores the derivative of the round( ) function and passes on the incoming gradient as if the function was an identity function.

In a first embodiment, the same quantizer is thus used for all deconvolutional layers deconvᵢ.

$${dconv}_{i} = \frac{newround ( {deconv}_{i} * quantizer )}{quantizer}$$

$$with$$

$$quantizer = {2}^{n}$$

$$n = bits - 1 - ceil ( {log}_{2} ( max ( abs ( X ) ) ) )$$

In this case the quantizer is stored and transmitted to the decoder. The weights and biases of each deconvᵢ are quantized using the same quantizer (deconvᵢ*quantizer) and transmitted to the decoder for inference. During the inference, all the operations are performed in integer and the outputs of each deconvᵢ are clamped to [−2^{nbits-1}, +2^{nbits+1}]. At the end of decoding, the output is finally rescaled to the initial range (e.g. [0,256] if output images are in 8 bits) using quantizer.

In a variant, a quantizer is set for each deconvolutional layer deconvᵢ.

$${dconv}_{i} = \frac{newround ( {deconv}_{i} * quantizer )}{quantizer}$$

With

$${quantizer}_{i} = {2}^{{n}_{i}}$$

$${n}_{i} = nbits - 1 - ceil ( {log}_{2} ( max ( abs ( {deconv}_{i} ) ) ) )$$

In this case the {quantizerᵢ} are stored and transmitted to the decoder

The decoder applies a dequantizer to each deconvolutional layer deconvᵢ using the associated transmitted quantizer quantizerᵢ during the inference decoding stage.

In a step S608, the encoder neural network is trained, i.e., the parameters of the encoder neural network are updated, until a stop criteria is reached to continue learning the encoder parameters (e.g. weights and biases). The stop criteria may be reached in the case where epoch_curr is equal to number_of_epochs or in the case where the Loss is below a predefined value.

Freezing the parameters of the deconvolutional layers in the decoder neural network while continuing learning, i.e., updating, the parameters of the convolutional layers in the encoder neural network, makes it possible to compensate for the distortion induced by the quantization of the network parameters (weights and biases). The loss thus continues to decrease until the end of the training.

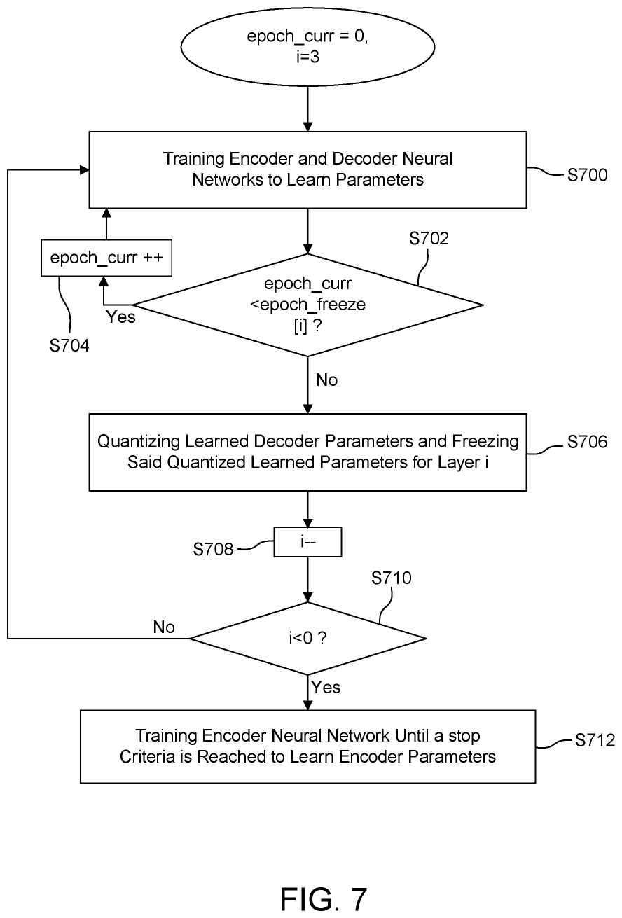

FIG. 7 illustrates an example of flowchart of a training method of a neural network end-to-end autoencoder according to another embodiment. In the method of FIG. 6, all the parameters of the decoder neural networks are quantized and frozen at the same epoch. i.e., when epoch_curr is larger than or equal to epoch_freeze.

In the embodiment of FIG. 7, the parameters of the decoder neural networks are quantized and frozen at different epochs. An index i is initialized to an index value associated with the deconvolution layer that is the closest to the output. e.g., to the value 3, i being an index used identify the deconvolutional layers in the decoder neural network. In the present description i varies from 0 to 3. However, i may vary from 1 to 4 instead. This is only a question of convention.

In a step S700, the encoder and decoder neural networks are trained to learn their parameters (e.g., weights and biases) for one epoch, one cycle through the full training dataset. The parameters are floating point parameters.

In a step S702, the current number of epoch epoch_curr is compared to a value epoch_freeze[i], e.g. epoch freeze[3]=number_of_epochs/2, epoch_freeze[2]=5*number_of_epochs/8, epoch_freeze[1]=6*number_of_epochs/8, epoch_freeze[0]=7*number_of_epochs/8. In the case where the current number of epochs epoch_curr is below epoch freeze[i], the method continues at step S704. At step S704, the current number of epoch epoch_curr is incremented by one and the method continues for a next epoch at step S700.

In the case where the current number of epochs epoch_curr is larger than or equal to epoch_freeze[i], the method continues at S706.

In a step S706, the learned decoder parameters of the decoder layer of index i, i.e., the deconvolution layer deconvᵢ, are quantized and frozen. The various embodiments disclosed with respect to FIG. 6 for the quantization apply similarly at step S706. Said otherwise, the parameters (e.g. weights and biases) of the deconvolutional layer deconvᵢ of the decoder neural network are not updated anymore until the end of the training. Since the last layer, i.e. the layer that is the closest to the output of the decoder is the most important layer in terms of impact on the reconstruction performance, the parameters of this layer are frozen first. With respect to FIG. 7, the parameters of deconv3 are quantized and fixed first, then the parameters of deconv2 are quantized and frozen, then parameters of deconv1 are quantized and frozen. Finally, the parameters of deconv0 are quantized and frozen.

In a step S708, the index i is decreased. At step S710, i is compared with zero (with 1 in the case where i varies from 1 to 4). In the case where i is strictly below zero then the method continues at step S712 otherwise the method continues at step S700. It should be noted that the deconvolution layers may be indexed differently, i.e. the layer that is the closest to the output of the decoder being indexed by 0 while the one being closest to the input being indexed by 3. In this latter case, i initialized to the value 0, is increased by 1 at step S708 and compared with 3 at step S710. Thus, the parameters of the deconvolutional layers are quantized and frozen layer by layer from the layer that is the closest to the output of the decoder up to the layer that is the closest to the input of the decoder.

In a step S712, the encoder neural network is trained, i.e. the parameters of the encoder neural network are updated, until a stop criteria is reached to continue learning the encoder parameters (e.g. weights and biases). The stop criteria may be reached in the case where epoch_curr is equal to number_of_epochs or in the case where the Loss is below a predefined value.

In a variant of the method of FIG. 7, the time instant where the learned decoder parameters of the decoder layer of index i are quantized and frozen is determined with respect to a loss evolution instead of a fixed number of epochs.

Indeed, the choice of the number of epochs is an issue in training neural networks. Too many epochs can lead to overfitting of the training dataset while too few epochs may result to an underfit model. Early stopping is a method that stops training once the model performance stops improving the validation dataset. An early stopping technique consists in stop training when the best validation error is at least Ne epochs past, i.e., when there is a plateau.

Early stopping with plateau detection is described below:

```
max_plateau = Ne
best_loss = Inf
best_epoch = 0
For epoch in range(max_epoch)
  current_loss= evaluate_Loss( )
  If(current_loss<best_loss)
    best_loss − current_loss
    best_epoch = epoch
  else:
    if((epoch −best_epoch) >max_plateau)
      early_stop = True
      break
```

This early stopping is applied at each quantization and freeze of a deconvolution layer. First, the learned decoder parameters of deconvolution layer deconv3 are quantized and frozen. Then, when a plateau is detected, the learned decoder parameters of the deconvolution layer deconv2 are quantized and frozen and so on until deconv0. Thus, the parameters of the deconvolutional layers are quantized and frozen layer by layer from the layer that is the closest to the output of the decoder up to the layer that is the closest to the input of the decoder.

As explained previously, the methods disclosed with respect to FIGS. 6 and 7 are not limited to the decoder and may be also implemented in the encoder wherein the encoder comprises either GDN or ReLU activation function as depicted on FIGS. 4A and 4B. In another embodiment, the methods disclosed with respect to FIGS. 6 and 7 may also apply during training to both the encoder and decoder. In this latter case, the deconvolution layers of the decoder are quantized and frozen first, layer by layer, at different epochs while the deconvolution layers of the encoder are then progressively quantized and frozen layer by layer at different epochs from the layer closest to the output (conv3) of the encoder up to the layer closest to the input (conv0) of the encoder. This latter solution provides a lightweight encoder/decoder architecture.

In one embodiment, a method is disclosed that comprises training encoder and decoder neural networks to learn encoder and decoder parameters, wherein the method comprises, during training, quantizing and freezing learned decoder parameters decoding layer per decoding layer at different epochs.

In an example, quantizing and freezing learned decoder parameters decoding layer per decoding layer at different epochs comprises quantizing and freezing said learned decoder parameters decoding layer per decoding layer at different epochs from the layer closest to an output of the decoder neural network up to the layer closest to an input of said decoder neural network.

In an example, a same quantizer is used to quantize learned decoder parameters of all decoding layers.

In an example, a particular quantizer is associated with each decoding layer of said decoder neural network and used to quantize learned decoder parameters of said decoding layer.

In an example, the decoder neural network comprises deconvolution layers, each followed by a Rectified Linear Unit.

In one embodiment, a decoder neural network is also disclosed that comprises deconvolution layers, each followed by a Rectified Linear Unit, wherein the parameters of the decoder neural network are integer parameters learned by the above method.

In one embodiment, a method is disclosed that comprises training encoder and decoder neural networks to learn encoder and decoder parameters, wherein the method comprises, during training, quantizing and freezing learned encoder parameters encoding layer per encoding layer at different epochs.

In an example, quantizing and freezing learned encoder parameters encoding layer per encoding layer at different epochs comprises quantizing and freezing said learned encoder parameters encoding layer per encoding layer at different epochs from the layer closest to an output of the encoder neural network up to the layer closest to an input of said encoder neural network.

In an example, a same quantizer is used to quantize learned encoder parameters of all encoding layers.

In an example, a particular quantizer is associated with each encoding layer of said encoder neural network and used to quantize learned encoding parameters of said encoding layer. In an example, the encoder neural network comprises deconvolution layers, each followed by a Rectified Linear Unit.

In one embodiment, an encoder neural network is also disclosed that comprises deconvolution layers, each followed by a Rectified Linear Unit, wherein the parameters of the encoder neural network are integer parameters learned by the above method.

A computer program is also disclosed that comprises program code instructions for implementing the methods disclosed above when executed by a processor.

A computer readable storage medium is disclosed that has stored thereon instructions for implementing the methods disclosed above when executed by a processor.

Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding and inverse quantization. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream. The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”. “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A. B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method comprising training an autoencoder neural network comprising an encoder neural network and a decoder neural network, the method comprising:
training the encoder and decoder neural networks to learn encoder and decoder parameters for at least one epoch;
determining that a number of epochs is above a value;
quantizing the decoder parameters of at least one layer of the decoder neural network and freezing the quantized decoder parameters responsive to the determining; and
training the encoder neural network to update encoder parameters.

2. The method of claim 1, wherein quantizing the decoder parameters of at least one layer of the decoder neural network and freezing the quantized decoder parameters comprises quantizing the decoder parameters and freezing the quantized decoder parameters decoding layer per decoding layer at different epochs from the layer closest to an output of the decoder neural network up to the layer closest to an input of said decoder neural network.

3. The method of claim 1, wherein a same quantizer is used to quantize decoder parameters of all decoding layers.

4. The method of claim 1, wherein a particular quantizer is associated with each decoding layer of said decoder neural network and used to quantize decoder parameters of said decoding layer.

5. The method of claim 1, wherein the decoder neural network comprises deconvolution layers, each followed by a rectified linear unit.

6. (canceled)

7. A computer readable storage medium having stored thereon instructions for implementing the method according to claim 1 when executed by a processor.

8-14. (canceled)

15. The method of claim 1, wherein the encoder parameters are in floating point and the quantized decoder parameters are integers.

16. The method of claim 1, wherein quantizing the decoder parameters of at least one layer of the decoder neural network and freezing the quantized decoder parameters comprises quantizing the decoder parameters of all layers of the decoder neural network and freezing the quantized decoder parameters.

17. The method of claim 1, wherein quantizing the decoder parameters of at least one layer of the decoder neural network and freezing the quantized decoder parameters comprises quantizing the decoder parameters and freezing the quantized decoder parameters decoding layer per decoding layer at different epochs.

18. An autoencoder neural network comprising an encoder neural network and a decoder neural network, wherein the autoencoder neural network comprises one or more processors and at least one memory coupled to said one or more processors, wherein said one or more processors are configured to perform:
training the encoder and decoder neural networks to learn encoder and decoder parameters for at least one epoch;
determining that a number of epochs is above a value;
quantizing the decoder parameters of at least one layer of the decoder neural network and freezing the quantized decoder parameters responsive to the determining; and
training the encoder neural network to update encoder parameters.

19. The autoencoder of claim 18, wherein quantizing the decoder parameters of at least one layer of the decoder neural network and freezing the quantized decoder parameters comprises quantizing the decoder parameters of all layers of the decoder neural network and freezing the quantized decoder parameters.

20. The autoencoder of claim 18, wherein quantizing the decoder parameters of at least one layer of the decoder neural network and freezing the quantized decoder parameters comprises quantizing the decoder parameters and freezing the quantized decoder parameters decoding layer per decoding layer at different epochs.

21. The autoencoder of claim 18, wherein quantizing the decoder parameters of at least one layer of the decoder neural network and freezing the quantized decoder parameters comprises quantizing the decoder parameters and freezing the quantized decoder parameters decoding layer per decoding layer at different epochs from the layer closest to an output of the decoder neural network up to the layer closest to an input of said decoder neural network.

22. The autoencoder of claim 18, wherein the encoder parameters are in floating point and the quantized decoder parameters are integers.
